(19) United States
(12) Patent Application Publication
(10) Pub. No.: US 2010/0015191 A1
(43) Pub. Date: Jan. 21, 2010

(54) DEVICE AND METHOD FOR CONTROLLING INSECTS

(75) Inventor: Jacob Allen Zupan, Yardley, PA (US)

Correspondence Address: WYETH LLC;PATENT LAW GROUP, 5 GIRALDA FARMS, MADISON, NJ, 07940, US

(73) Assignee: Wyeth, Madison, NJ (US)

(21) Appl. No.: 12/505,890

(22) Filed: Jul. 20, 2009

Related U.S. Application Data
(60) Provisional application No. 61/082,330, filed on Jul. 21, 2008.

(51) Int. Cl. A01N 25/34; A01N 47/34; A01N 59/16

(52) U.S. Cl. 424/403; 514/590; 424/617

(57) ABSTRACT

The present invention provides novel insecticidal devices, and methods for controlling insects in a homeothermic animal.

### CROSS-REFERENCE TO RELATED APPLICATIONS

This application claims the benefit under 35 U.S.C. §119(e) to co-pending U.S. provisional application No. 61/082,330 filed Jul. 21, 2008, which is hereby incorporated by reference in its entirety.

### FIELD OF THE INVENTION

The present invention relates to a device and method for controlling insects.

### BACKGROUND OF THE INVENTION

Metaflumizone and other ectoparasiticidal agents (e.g., fipronil and imidacloprid) are useful for the prevention and control of infestation by ectoparasites in warm-blooded animals. Such agents that have found particular application for the control of ectoparasites, e.g., fleas, particularly on companion animals such as dogs, cats or horses and horn flies, particularly on cattle. Topical administration is a preferred method for administering ectoparasiticidal agents, to reduce the possibility of ingestion by the subject animal and/or run-off and waste of the active composition.

As ectoparasite seasons persist significantly longer than 4-6 weeks in many areas, multiple doses are often required to achieve substantial protection for an entire season. It is, therefore, desirable to formulate applications that would offer substantial protection from ectoparasites, for a prolonged period, e.g., a whole season, in one application. Such applications would offer convenience and efficiency benefits, and would reduce or eliminate the risk of a gap in protection stemming from poorly-timed administration of additional doses. Protection following application of metaflumizone and other useful arthropodicidal agents known in the art (e.g., fipronil and imidacloprid), however, is currently limited in duration to approximately 4-6 weeks.

Current limitations on protection are usually caused by loss of the active ingredient due to environmental or biological effects, including ruboff, photodegredation, and animal metabolism. As ectoparasite seasons persist significantly longer than 4-6 weeks in many areas, multiple doses are currently often required to achieve substantial protection for an entire season. It is, therefore, desirable to formulate applications that would offer substantial protection from ectoparasites (e.g., fleas, ticks and horn flies), as well as other arthropods, for the whole season in one application. Such applications would offer convenience and efficiency benefits, and would eliminate the risk of a gap in protection stemming from poorly-timed administration of additional doses.

Insecticidal devices, e.g., animal ear tags, neck-worn collars and pendants are a means of controlled application of an insecticide. The use of pest strips, collars, bands, and tags which have an insecticide contained throughout the substrate of the final device are described in U.S. Pat. No. 3,318,679; U.S. Pat. No. 3,944,662; U.S. Pat. No. 3,756,200; U.S. Pat. No. 3,942,480 and U.S. Pat. No. 4,195,075; U.S. Pat. No. 4,674,445; U.S. Pat. No. 4,767,812; U.S. Pat. No. 4,967,698; U.S. Pat. No. 5,620,696; U.S. Pat. No. 5,342,619; U.S. Pat. No. 5,104,569; U.S. Pat. No. 6,956,099; and U.S. Patent Publication No. 2006/0288955. Each of the aforementioned patents and patent publication is hereby incorporated herein by reference in its entirety.

A problem with insecticidal devices is that breakage or weakness of the substrate can result from the incorporation of an active ingredient or mixture of active ingredients. Further, diminution of insecticidal activity can result from incorporation of the active ingredient in the polymer matrix. Moreover, the concentration of active component is a limiting factor in the strength of the resulting insecticidal device.

Fabricating matrix-type delivery devices with active agents exhibiting high-melting points and a strong crystalline structure (e.g., metaflumizone) presents particular problems. Common matrices are various thermoforming polymers (e.g., PVC and polyurethane), which are plasticized to reduce brittleness and breakage during use. High-melting point solids typically have very low solubilities in the matrix reducing or preventing migration of active agent to the surface, thus greatly reducing the effectiveness of a delivery device. Thus, a balance must be reached, such that there is sufficient molecular movement to continuously transport active agent to the surface of the device.

Metaflumizone is particularly difficult to formulate and/or use to fabricate matrix-type delivery devices due to its insolubility in many solvents and its instability in the presence of particular solvents. Surprisingly, organic, low molecular weight amide solvents, e.g., diethyltoluamide (DEET), used as both a co-solvent with an active parasiticidal agent (e.g., metaflumizone) and co-plasticizer for use in fabrication of matrix-type delivery devices such as animal ear tags, neck-worn collars, pendants and the like provides improved matrix-type delivery devices capable of establishing prolonged protection against parasitic infections.

### SUMMARY OF THE INVENTION

The present invention relates to devices for use with homeothermic animals and comprising an effective amount of an insecticide, e.g., metaflumizone, in device and a low molecular weight amide solvent.

In certain embodiments, the device is in the form of an animal ear tag, neck collar or pendant.

In certain embodiments, the device is fabricated from a thermoplastic resin, e.g., polyvinylchloride (PVC) polymer or copolymer, preferably a solid dispersion of PVC.

In certain embodiments, the device comprises metaflumizone and one or more additional insecticidal agents.

In certain embodiments, the invention provides the aforementioned device for use in controlling insects in a localized environment, comprising contacting an animal with said device. In preferred embodiments the device provides an animal protection from fleas or horn flies.

In certain embodiments, the invention provides a composition comprising a thermoplastic resin, metaflumizone and a low molecular weight amide solvent. In a preferred composition said low molecular weight solvent is DEET. A further preferred embodiment, said composition comprises by weight about 5% to about 30% of metaflumizone, about 40% to about 85% of said thermoplastic resin, and about 10% to about 50% of said low molecular weight amide solvent.

### DETAILED DESCRIPTION OF THE INVENTION

The present invention provides an insecticidal device for use with homeothermic animals and comprising an effective amount of an insecticide and a low molecular weight amide solvent. The devices are particularly advantageous in overcoming problems associated fabricating such devices comprising a high-melting point, highly crystalline active agent in a matrix-type delivery device. Such problems include breakage or weakness of devices that can result from the incorporation of an active ingredient and ineffective application of active agent due to e.g., low concentration or poor solubility. The device may be in any shape or form suitable for attachment to an animal. Preferably, the device is in the form of an ear tag (e.g., cattle ear tag), neck collar or pendant.

Without being bound by theory, it is believed that the improved properties of the devices derive from the ability of the low molecular weight amide solvent to act as a co-solvent for the active agent and a co-plasticizer of the polymeric matrix. Thus, active agent is dissolved in the solvent at a high concentration and in a non-crystalline state. The plasticizer activity of the solvent keeps the polymeric matrix pliable, preventing breakage. Moreover, the dual nature of the low molecular weight amide solvent allows active agent to be delivered to the surface of the polymer matrix efficiently and at a controlled rate. As the solvent migrates from the interior to the surface of the device, solubilized active agent is also carried to the surface. The improved properties of the devices described herein, e.g., an ear tag, neck collar or pendant, make them useful for the prevention and control of infestation by ectoparasites in warm-blooded animals.

Solvents useful for fabricating the devices described herein have the solubilizing and plasticizing properties. Preferably, a solvent has plasticizing properties and efficiently solubilizes high-melting point active agents with a strong crystalline structure. More preferably, a solvent has plasticizing properties efficiently solubilizes an ectoparaciticide, most preferably metaflumizone. A preferred class of solvents is the low molecular weight amide solvents, which are preferably less than 300 Daltons, and even more preferably less than 200 Daltons. Preferred low molecular weight amide solvents are diethyltoluamide (DEET), dimethylacetamide, 2-pyrrolidone, and N-methylpyrrolidone. A most preferred solvent is DEET.

Active agents include insecticidal agents, more preferably ectoparasiticidal and arthropodicidal agents. Active agents include, for example and without limitation, pyrethroids, organophosphates, organochlorines, and carbamates.

Pyrethroid insecticidal agents include, for example and without limitation, cyano(3-phenoxyphenyl)methyl 4-chloro-α-(1-methylethyl)benzeneacetate(fenvalerate), and the active isomer thereof (esfenvalerate); cyano(3-phenoxyphenyl)methyl 3-(2,2-dichloroethenyl)-2,2-dimethylcyclopropanecarboxylate, (cypermethrin); (3-phenoxyphenyl)methyl 3-(2,2-dichloroethenyl)-2,2-dimethylcyclopropanecarboxylate, (permethrin); (3-phenoxyphenyl)methyl 2,2-dimethyl-3-(2-methyl-1-propenyl)cyclopropanecarboxylate(phenothrine); cyano(4-fluoro-3-phenoxyphenyl)methyl 3-(2,2-dichloroethenyl)-2,2-dimethylcyclopropanecarboxylate(cyfluthrin); [1α,α(Z)]-(±)-cyano-(3-phenoxyphenyl)methyl 3-(2-chloro-3,3,3-trifluoro-1-propenyl)-2,2-dimethylcyclopropanecarboxylate(cyhalothrine); [1α(S*),3α(Z)]-(±)-cyano-(3-phenoxyphenyl)methyl 3-(2-chloro-3,3,3-trifluoro-1-propenyl)-2,2-dimethylcyclopropanecarboxylate(lambda-cyhalotrin); cyano(3-phenoxyphenyl)methyl-2,2-dimethyl-3-(2-methyl-1-propenyl)cycloprop anecarboxylate(cyphenothrin); (RS)-cyano-(3-phenoxyphenyl)methyl(S)-4-(difluoromethoxy)-α-(1-methylethyl)benzeneacetate(flucythrinate); cyano(3-phenoxyphenyl)methyl 2,2-dimethyl-3-(1,2,2,2-tetrabromoethyl)cyclopropanecarboxylate(tralomethrin); and [1α,3α(Z)]-(±)-(2-methyl[1,1′-bipheny]-3-yl)methyl 3-(2-chloro-3,3,3-trifluoro-1-propenyl)-2,2-dimethylcyclopropanecarboxylate(bifenthrin).

Organophosphate insecticidal agents include, for example and without limitation, O,O-diethyl O-2-isopropyl-6-methylpyrimidin-4-yl phosphorothioate(diazinon); S-1,2-bis(ethoxycarbonyl)ethyl O,O-dimethyl phosphorodithioate(malathion); O,O-dimethyl O-4-nitro-m-tolyl phosphorothioate(Sumithion®); and O,O,O,O′-tetraethyl S,S′-methylene bis(phosphorodithioate)(ethion).

Organochlorine insecticidal agents include, for example and without limitation, C,C′-(1,4,5,6,7,7-hexachloro-8,9,10-trinorborn-5-en-2,3-ylene)(dimethyl sulfite)(endosulfan) and 1,1,1,-trichloro-2,2-bis(4-methoxyphenyl)ethane(methoxychlor).

Carbamate insecticidal agents include, for example and without limitation, 2,3-dihydro-2,2-dimethylbenzofuran-7-yl methylcarbamate(carbofuran); 2-isopropoxyphenyl methylcarbamate(propoxur); 1-naphthyl methylcarbamate(carbaryl); 2,3-isopropylidenedioxyphenyl methylcarbamate(bendiocarb).

More preferred active agents include metaflumizone, fipronil, dinotefuran, permethrin, pyriproxyfen, S-methoprene, imidacloprid, or any combination thereof. A most preferred active agent is metaflumizone. Metaflumizone is known in the art by its chemical name: (E Z)-2-[2-(4-cyanophenyl)-1-[3-(trifluoromethyl)phenyl]ethylidene]-N-[4-(trifluoromethoxy)phenyl]hydrazinecarboxamide and is described in U.S. Pat. No. 5,543,573, which is herein incorporated by reference in its entirety. In certain embodiments, insecticidal devices contain a combination of one or more of the aforementioned active agents.

Insecticidal devices may be used, for example and without limitation, for controlling insect infestation of an animal, by contacting the animal with the device. In certain embodiments, an insecticidal device may be used to control fleas on an animal. In preferred embodiments, an insecticidal device may be used to control fleas on a cat, dog or horse. In certain embodiments, an insecticidal device may be used to control horn flies on an animal. In preferred embodiments, an insecticidal device may be used to control horn flies on cattle species.

Polymeric matrix-type delivery devices such as animal ear tags, neck-worn collars, pendants may be fabricated from any polymer or co-polymer compatible with an active agent and solvent. Preferred polymeric matrices are thermoplastic resins, more preferably a solid dispersion of polyvinylchloride polymer or copolymer. Additional thermoplastic resins and other materials suitable for polymeric matrix-type delivery devices, e.g., polyurethanes, are well known to those of ordinary skill in the art.

It should be understood that the invention is not limited to ear tags, neck-worn collars and pendants. Thus, the device could take other forms such as, without limitation, a tail tag, ear clip, leg bracelet, other type of collar, horse strip, medallion, chain tag or other device which could be attached to an animal. The final polymer will preferably have a Shore hardness of 70-90 A units, a number average molecular weight which is not less than about 90,000, and a melting range within the range of about 70° C. to 190° C.

Ultraviolet light stabilizers such as 2-(2′-hydroxy-5′-methyl phenyl)-benzotriazole, fillers, lubricants, dyes, antioxidants such as octadecyl 3,5-di-tert-butyl-4-hydroxy-hydrocinnamate, pigments, and other inert ingredients may be incorporated into the formulation from zero to 2% by weight of the final product for serving their accepted functions which are well known to those skilled in the art. The foregoing optional substituents are generally added after the insecticide has been absorbed into the polymer.

As a general process of preparing the components into a dry blend for molding processes, beads or pellets of PVC or other suitable resin are milled or ground to finer than approximately a 16 mesh size. The ground resin is placed in a mixer and when the powder reaches a temperature of approximately 170° F., the ectoparasiticidal compound and solvent are then added and mixed until material is completely absorbed. Optionally, other ingredients such as pigments, fillers, lubricants and antioxidants may be added to the mixture. A preferred filler and/or pigment is titanium dioxide, which can be present at anywhere from about 0.1% to about 5%. Most preferably, at about 1%. The resulting free-flowing powder can be processed and molded in a well known manner.

As an alternative to the molding techniques described above, the insecticidal device can be formed by coating a resin, e.g., PVC, ectoparasiticidal active compound and optional additional components onto a substrate. The substrate is typically but not necessarily inactive and can be selected from any of various suitable materials such as porous or homogeneous plastic sheets, fabrics made of natural or synthetic fibers or combinations thereof, natural or synthetic leather, plastic mesh pattern cloths, coated fiberglass screening or cloth, and coated plastic screening. Substrates are typically used in those applications where added mechanical strength is needed for the final product because of very high loadings of the ectoparasiticidal compound in the polymeric matrix. It may also be desirable to use the higher mechanical strength substrates with comparatively lower loadings of ectoparasiticidal compound in those instances where high strength is necessary at the point of attachment of the device to the animal.

Among the various suitable processes which can be used for coating the substrates with the polymer and ectoparasiticidal compound are spread coating, dip coating and extrusion or coextrusion lamination techniques. In dip coating processes, the substrate is cut to shape and is dipped into the solubilized mixture which has the desired flow properties to obtain a smooth coating and to diminish the tendency for the solution to drip from the substrate prior to drying. Following drying, the coated substrate can again be dipped into the mixture to build up the necessary coating thickness.

The substrates can also be coated by melting the resin, ectoparasiticidal active compound and optional additional components in an extruder and forcing the melt through a slit die onto the substrate. The coated substrate can then be cooled on rollers followed by cutting into the desired shape of the final product such as an ear tag.

A preferred range for polymer and insecticide is about 40% to 60% by weight polymer and about 5% to about 30% ectoparasiticidal active compound with the remaining balance comprising the low molecular weight solvent (up to about 40% by weight) and up to 10%, 5% or 2% by weight inert ingredients such as antioxidants, ultraviolet light stabilizers and pigments, all well known to those skilled in the art (all weight percents based on final product).

Polymeric matrix-type delivery devices typically comprise on a weight basis of about 40% to 90% of a polyvinylchloride or other thermoplastic resin; and about 1% to 30% of active agent, e.g., metaflumizone. Depending upon the characteristics of the polyvinylchloride or other thermoplastic resin chosen, other optional components may include about 0.0% to 4.0% of a processing stabilizer such as epoxidized soybean oil; about 0.02% to 10.0% of a lubricant such as stearic acid; about 0.3% to 0.5% of a chelating agent such as trinonylphosphite; about 01% to 2.5% of a heat processing stabilizer such as calcium-zinc stearate; about 0% to 5.0% of a flow agent such as SiO₂; about 0% to 35.0% of insecticidal synergists and migration accelerators such as piperonyl butoxide; about 0% to 25.0% of a plasticizer or mixture of plasticizers such as dioctylphthalate, benzylbutylphthalate, dibutylphthalate, citrate esters, adipates or sebacates; and about 1% to 30% of additional insecticidal agents, such as amitraz, fipronil, imidachloprid, permethrin, pyrethrins, piperonyl butoxide, chlorfenapyr or fenothrin. If desired, a colorant, in the amount of about 0.5 to 2.0% can be added, especially to provide distinction of animals with the metaflumizone-bearing device.

In one embodiment, an animal ear tag, neck collar or pendant comprises about 40% to 90% of a thermoplastic resin; 5% to 30% of metaflumizone; and 20%-40% of a low molecular weight amide solvent, e.g., DEET. Optionally present are up to 4.0% of a processing stabilizer; 0.2% to 10.0% of a lubricant; 0.3% to 0.5% of a chelating agent; 1% to 2.5% of a heat processing stabilizer; 0% to 5.0% of a flow agent; up to 35.0% of insecticidal synergists and migration accelerators; 0.5 to 2.0% colorant; and up to 30% of one or more additional insecticidal agents may also be added. In a further embodiment, the composition is impregnated or coated onto a mesh matrix component of a natural or synthetic cloth or fiber or wire or a solid dispersion of polyvinylchloride polymer or copolymer to form an ear tag, neck collar or hanging pendant device.

In a particular embodiment, the present invention provides a composition comprising on a weight by volume basis:
(a) about 5% to about 30% of metaflumizone;
(b) about 40% to about 85% of said thermoplastic resin; and
(c) about 10% to about 50% of said low molecular weight amide solvent.

For some applications, it has been found that the use of impregnated coated, extruded or co-extruded fabric matrix tags of a one piece design offers several advantages over conventional one piece molded tags. When a composition containing an insecticidally active ingredient or mixture of insecticidally active ingredients is fabricated on a matrix of natural or synthetic cloth or fiber mesh, or a wire mesh, the result is a stronger ear tag which is less prone to breakage and thus allows a greater range of compositions to be incorporated into the tag. Also, the one piece matrix animal ear tag, due to the strength of the matrix, is not as restricted in the means of attachment to the ear as a plastic molded ear tag. Such matrix materials are also suitably formed as neck collars or pendants.

The invention is further illustrated by the following non-limiting examples.

### EXAMPLES

Metaflumizone and DEET were weighed and combined in a suitable vessel. The mixture was heated and stirred until a solution is obtained. The PVC resin, dye and titanium dioxide were combined in a suitable mixer. Mixing was initiated with heating to ˜170° F. The metaflumizone/DEET solution was then added to the resin mixture and mixing was continued for about 3 h until material appeared dry. The dry resin mixture was then molded into ear tags using an injection molding machine with a barrel temperature of about 260-280° F. and a suitable mold.

### Example 1

| Ingredient | Percent | Quantity (g) |
|---|---|---|
| Metaflumizone (93.5%) | 10.70 | 534.8 |
| DEET | 22.60 | 1130.0 |
| SuperKleen S/K2223BF-70* | 65.70 | 3285.2 |
| Titanium dioxide | 1.00 | 50.0 |
| Total Weight | | 5000.0 |

*PVC resin premix, Alpha Gary

### Example 2

| Ingredient | Percent | Quantity (g) |
|---|---|---|
| Metaflumizone (93.5%) | 12.83 | 641.7 |
| DEET | 27.00 | 1350.0 |
| SuperKleen S/K2223BF-70* | 59.16 | 2957.8 |
| Titanium dioxide | 1.00 | 50.0 |
| D&C Violet #2 | 0.01 | 0.5 |
| Total Weight | | 5000.0 |

*PVC resin premix, Alpha Gary

### Example 3

| Ingredient | Percent | Quantity (g) |
|---|---|---|
| Metaflumizone (93.5%) | 16.04 | 802.0 |
| DEET | 33.60 | 1680.0 |
| Virgin PVC | 47.85 | 2392.5 |
| Epoxidized soybean oil | 1.50 | 75.0 |
| Titanium dioxide | 1.00 | 50.0 |
| FD&C Yellow #5 | 0.01 | 0.5 |
| Total Weight | | 5000.0 |

### Example 4

| Ingredient | Percent | Quantity (g) |
|---|---|---|
| Metaflumizone (93.5%) | 5.28 | 264.0 |
| DEET | 22.60 | 1130.0 |
| SuperKleen S/K2223BF-70* | 71.08 | 3554.0 |
| Titanium dioxide | 1.00 | 50.0 |
| D&C Red #17 | 0.04 | 2.0 |
| Total Weight | | 5000.0 |

*PVC resin premix, Alpha Gary

### Example 5

| Ingredient | Percent | Quantity (g) |
|---|---|---|
| Metaflumizone (93.5%) | 10.56 | 528.0 |
| DEET | 35.00 | 1750.0 |
| SuperKleen S/K2223BF-70* | 53.43 | 2671.5 |
| Titanium dioxide | 1.00 | 50.0 |
| FD&C Yellow #5 | 0.01 | 0.5 |
| Total Weight | | 5000.0 |

*PVC resin premix, Alpha Gary

The present invention is not to be limited in scope by the specific embodiments described herein. Indeed various modifications of the invention in addition to those described herein will be apparent to those skilled in the art from the foregoing description. Such modifications are intended to fall within the scope of the appended claims.

It is further to be understood that all values are approximate and are provided for description. All references cited and discussed in this specification are incorporated herein by reference in their entirety and to the same extent as if each reference was individually incorporated by reference.

What is claimed is:

1. An animal insecticidal device comprising metaflumizone and a low molecular weight amide solvent.

2. The animal insecticidal device of claim 1 in the form of an ear tag, neck collar or pendant.

3. The animal insecticidal device of claim 1, wherein said low molecular weight amide solvent is selected from the group consisting of DEET, dimethylacetamide, 2-pyrrolidone and N-methylpyrrolidone.

4. The animal insecticidal device of claim 3, wherein said low molecular weight amide solvent is DEET.

5. The animal insecticidal device of claim 1, wherein the device comprises a thermoplastic resin.

6. The animal insecticidal device of claim 5, wherein the thermoplastic resin is a polyvinylchloride polymer or copolymer.

7. The animal insecticidal device of claim 1, comprising about 5-30% metaflumizone by weight.

8. The animal insecticidal device of claim 1, further comprising one more additional insecticidal agent.

9. The animal insecticidal device of claim 1, further comprising one or more processing stabilizer, chelating agent; heat processing stabilizer, flow agent; insecticidal synergist, migration accelerators, or colorant.

10. The animal insecticidal device of claim 1, further comprising titanium oxide.

11. The animal insecticidal device of claim 1, wherein the device is fabricated by coating metaflumizone, the low molecular weight amide solvent and thermoplastic resin onto a substrate.

12. The animal insecticidal device of claim 1, wherein the device is fabricated by extrusion or coextrusion.

13. The animal insecticidal device of claim 1, which further comprises amitraz.

14. A method for controlling insects in a localized environment, comprising contacting an animal with the animal insecticidal device of claim 1.

15. The method of claim 14, for the control fleas.

16. The method of claim 14, wherein said animal is a cat, dog or horse.

17. The method of claim 16, comprising contacting said animal with a collar or pendent

18. The method of claim 14, for the control of horn flies.

19. The method of claim 14, wherein said animal is a type of cattle.

20. The method of claim 19, comprising contacting said animal with an ear tag.

21. A composition comprising a thermoplastic resin, metaflumizone and a low molecular weight amide solvent.

22. The composition of claim 21, wherein said low molecular amide solvent is DEET.

23. The composition of claim 21, comprising on a weight by volume basis:
(a) about 5% to about 30% of metaflumizone;
(b) about 40% to about 85% of said thermoplastic resin; and
(c) about 10% to about 50% of said low molecular weight amide solvent.
